(19) United States
(12) Patent Application Publication
(10) Pub. No.: US 2008/0031621 A1
(43) Pub. Date: Feb. 7, 2008

(54) CONTROLLING OPTICAL SIGNAL TRANSMISSION TO REDUCE OPTICAL SIGNAL DEGRADATION

(75) Inventors: Chien-Yu Kuo, Cupertino, CA (US); Wangsheng Zhang, Mountain View, CA (US); Yu-Yun Shih, Fremont, CA (US); Chau-Hong Kuo, Sunnyvale, CA (US)

Correspondence Address: APPLIED OPTOELECTRONICS, INC., 13111 JESS PIRTLE BLVD., SUGAR LAND, TX, 77478, US

(73) Assignee: APPLIED OPTOELECTRONICS, INC., Sugar Land, TX (US)

(21) Appl. No.: 11/828,595

(22) Filed: Jul. 26, 2007

Related U.S. Application Data
(60) Provisional application No. 60/820,457, filed on Jul. 26, 2006.

(51) Int. Cl. H04B 10/08

(52) U.S. Cl. 398/26

(57) ABSTRACT

An optical transmission system and method may control optical signal transmission in an optical network, such as a passive optical network (PON), to reduce degradation of one or more optical signals traveling over the same optical waveguide. In particular, optical signal transmission may be controlled to reduce carrier to noise ratio (CNR) degradation of an optical signal (e.g., a multichannel video signal) resulting from the effects of stimulated Raman scattering (SRS) and/or double Rayleigh backscattering (DRBS). The CNR degradation may be reduced by controlling transmission of one or more of a plurality of optical signals in the optical network based on various parameters affecting the contribution to CNR degradation by SRS and/or DRBS and affecting the performance of the optical transmission system. The optical signal transmission may be controlled by adjusting a preemphasis and/or transmitted power of the optical signal(s).

### CROSS-REFERENCE TO RELATED APPLICATIONS

This application claims the benefit of U.S. Provisional Patent Application Ser. No. 60/820,457 filed Jul. 26, 2006, which is fully incorporated by reference.

### TECHNICAL FIELD

The present invention relates to optical transmission systems and methods and more particularly, to an optical transmission system and method that controls optical signal transmission to reduce optical signal degradation.

### BACKGROUND INFORMATION

Various optical networks employ lasers as sources of data transmitted over the network. Such networks include passive optical networks (PONs) such as an Ethernet-based passive optical network (EPON), an ATM-based broadband passive optical network (BPON), and an ATM-based gigabit passive optical network (GPON). Such networks may employ fiber-to-the-home and fiber-to-the-premises (FTTH/FTTP) broadband network equipment.

PONs may be used to overlay a video RF signal in the optical fiber with a digital data signal. Thus, the PON can deliver the multiplier number of the wavelength division multiplexed (WDM) digital signals (e.g., digital data) together with the analog RF cable television (CATV) video signal (e.g., amplitude-modulated vestigial-sideband (AM VSB) CATV signal) through a single strand of single-mode optical fiber. Such an arrangement may be used to upgrade an existing digital network system to include the CATV video signal. Digital data, voice over internet protocol (VoIP) data, and video signals can all be included on the single optical fiber. This can reduce the cost of delivering the phone system, TV channels, and internet service to the end user in a metropolitan area.

In PONs, optical signals of different types may be sent in different directions and at different wavelengths. In some existing PON schemes, for example, the downstream digital data may be transmitted at a first wavelength and downstream analog video may be transmitted at a second wavelength, while upstream or back data from the end user may be transmitted at a third wavelength. In particular, the IEEE 802.3ah EPON standard specifies that Ethernet data be transmitted to the subscriber using the 1490 nm optical wavelength and that broadcast video be propagated on the same optical fiber using the 1550 nm optical wavelength.

When optical signals are transmitted in the same direction down the same optical waveguide on different wavelengths (e.g., when “overlaying” the RF video and digital channel signals), one or more of the optical signals can be degraded by optical interference or crosstalk as a result of stimulated Raman scattering (SRS) due to the fiber's non-linearity. In IEEE 802.3ah EPON networks, for example, the Ethernet (data) signal transmitted at 1490 nm amplifies any video signal transmitted at 1550 nm, and therefore interference can result in a noticeable degradation of video quality. A particularly egregious case occurs when an Ethernet idle pattern is transmitted because no data is available to transmit. This causes interference with broadcast video on certain channels. For analog television (TV) applications, the crosstalk or interference may manifest itself as a ghost image of the other signal or as a beat (i.e., moving lines in the picture). SRS between optical signals is a function of the signal levels, the optical wavelengths used, and the length of the optical waveguides or fibers.

In optical networks, signal quality may be measured by the carrier-to-noise ratio (CNR), which measures the level of a carrier signal relative to the noise. SRS interference may cause the CNR of a received optical video signal to degrade to below acceptable levels for several channels of the video signal, particularly lower-frequency channels. One approach to reducing the SRS degradation is to apply fixed pre-emphasis by boosting the power of the 1550 nm video signal at the lower RF channels in an attempt to overcome the degradation. However, there may be limitations as to how much pre-emphasis may be applied in an optical transmitter and optical network. Thus, this approach has drawbacks and limitations.

SRS may also be reduced or eliminated by selecting different optical wavelengths. For example, SRS would not be a serious problem in a PON having 1310 nm data and 1550 nm video data. In some applications, however, various standards, such as the IEEE 802.3ah standard, and industry practice require that downstream data be transmitted at 1490 nm. If the wavelength of the video transmission is moved as high as possible in the 1550 nm window, SRS degradation may also be reduced but only slightly. Another possible solution is to use different optical fibers for digital and video channels. Such a solution may require significant changes to existing optical networks and is undesirable for economic reasons.

In addition to SRS degradation, optical signal degradation is also caused by impurities in the fiber, which lead to the phenomenon of double Rayleigh backscattering (DRBS). Rayleigh scattering is the scattering of light, or other electromagnetic radiation, by particles much smaller than the wavelength of the light. This effect occurs when light travels in transparent solids, liquids, and gases. The amount of Rayleigh scattering that occurs is dependent upon the size of the particles and the wavelength of the light. In particular, the scattering coefficient, and hence the intensity of the scattered light, varies inversely with the fourth power of the wavelength, a relation known as the Rayleigh law.

DRBS causes RF phase fluctuation and is a function of the chirp of the optical signal (e.g., the RF video signal in a PON). Chirp refers to modulation-induced wavelength fluctuations in a signal generated by a direct-modulated laser. The RF phase fluctuation in the optical signal may cause intensity fluctuations at the receiving photodetector. This degrades the CNR of the optical signal in the same fashion as relative intensity noise (RIN) from a laser transmitter. Thus, DRBS in a fiber further degrades the CNR of the video signal in an optical network. Existing techniques for reducing CNR degradation caused by SRS do not address the CNR degradation caused by DRBS.

Therefore, reducing CNR degradation to improve signal quality in optical networks, such as PONs, is a complex proposition and presents a unique challenge considering the numerous different parameters that affect CNR degradation.

### BRIEF DESCRIPTION OF THE DRAWINGS

These and other features and advantages will be better understood by reading the following detailed description, taken together with the drawings wherein:

FIG. 1 is a functional block diagram of an optical network capable of reduced optical signal degradation, consistent with embodiments of the present invention.

FIG. 2 is a functional block diagram of an optical transmission system capable of providing reduced optical signal degradation in an optical network, consistent with embodiments of the present invention.

FIGS. 3A-3H are graphs illustrating carrier to noise ratio (CNR) in various optical networks based on simulations under various conditions.

FIG. 4 is a flow chart illustrating one method of controlling optical transmission in an optical network to reduce CNR degradation, consistent with embodiments of the present invention.

FIG. 5 is a flow chart illustrating one method of transmitting optical signals in an optical network with reduced CNR degradation, consistent with embodiments of the present invention.

FIG. 6 is a flow chart illustrating another method of controlling optical transmission in an optical network to reduce CNR degradation, consistent with embodiments of the present invention.

### DETAILED DESCRIPTION

An optical transmission system and method may control optical signal transmission in an optical network to reduce degradation of one or more optical signals traveling over the same optical waveguide. In particular, optical signal transmission may be controlled to reduce carrier to noise ratio (CNR) degradation of an optical signal resulting from the effects of stimulated Raman scattering (SRS) and/or double Rayleigh backscattering (DRBS). The CNR degradation may be reduced by controlling transmission of one or more of a plurality of optical signals in the optical network based on various parameters affecting the contribution to CNR degradation by SRS and/or DRBS and affecting the performance of the optical transmission system. The parameters may include the optical wavelengths and power levels of the optical signals and the length of the optical transmission waveguides (e.g., the optical fibers). As will be described in greater detail below, optical signal transmission may be controlled by adjusting a preemphasis and/or transmitted power of the optical signal(s).

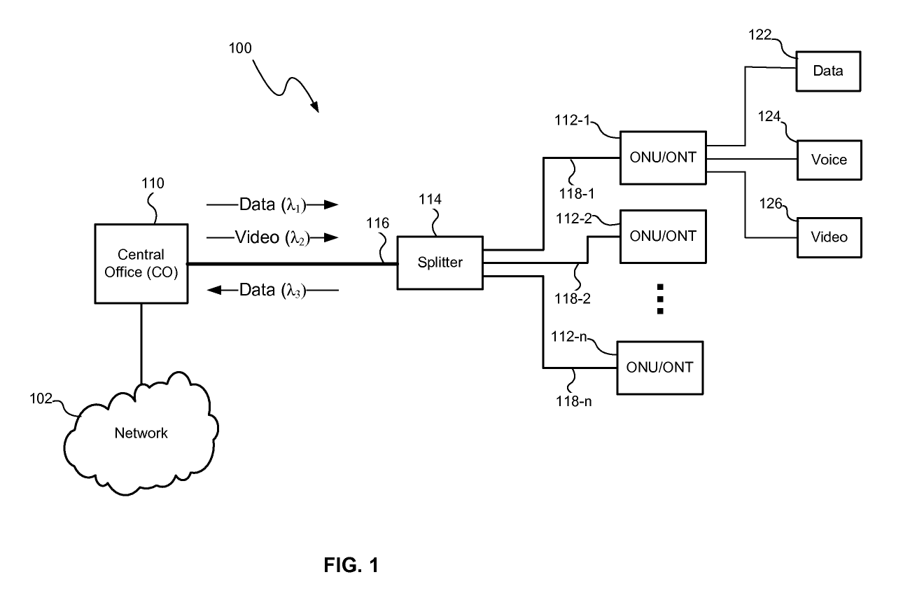

Referring to FIG. 1, an optical transmission system and method, consistent with embodiments of the present invention, may be used with an optical network 100. According to one embodiment of the optical network 100, a transmitter node 110 may be coupled to a plurality of receiver nodes 112-1 to 112-n via optical waveguides or fibers 116, 118-1 to 118-n and a splitter 114. Where the optical network 100 is a passive optical network (PON), the transmitter node 110 may be a central office (CO) including an optical line terminal (OLT) and the receiver nodes 112-1 to 112-n may include an optical networking unit (ONU) or optical networking terminal (ONT).

One application of the optical network 100 is to provide fiber-to-the-home (FTTH) or fiber-to-the-premises (FTTP) capable of delivering voice, data, and video services across a common platform. In this application, the transmitter node 110 may be coupled to a data network 102, such as the internet or another data network. The splitter 114 may be a 1:32 optical splitter capable of coupling to up to thirty-two (32) ONU/ONT receiver nodes 112-1 to 112-n. Different deployments of the optical network 100 may have different distances between the CO node 110 and the splitter 114, the splitter 114 and the ONU/ONT nodes 112-1 to 112-n, and the CO node 110 and the ONU/ONT nodes 112-1 to 112-n. The optical network 100 may also include other equipment between the nodes 110 and 112-1 to 112-n, such as optical amplifiers and wavelength division multiplexing (WDM) equipment (not shown). Each of the ONU/ONT receiver nodes 112-1 to 112-n may be coupled, either indirectly or directly, to a data unit 122 (e.g., a computer), a voice unit 124 (e.g., a telephone), and/or a video unit 126 (e.g., a television).

According to one embodiment, the optical network may be an Ethernet PON (EPON) complying or compatible with the IEEE 802.3ah standard. According to another embodiment, the optical network may be a broadband PON (BPON) complying or compatible with the ITU-T G.983 standard. According to a further embodiment, the optical network may be a gigabit PON (GPON) complying or compatible with the ITU-T G.984 standard. Although these types of PONs are specifically described herein, other types of optical networks may also be used with the systems and methods described herein.

The transmitter node 110 may transmit at least first and second optical signals at first and second wavelengths (λ₁, λ₂). In one embodiment, the first optical signal may include a digital data signal and the second optical signal may include a multichannel analog video signal. The transmitter node 110 may also receive a third optical signal at a third wavelength (λ₃). In a PON, for example, the first and third optical signals may carry data and/or voice and the second optical signal may be a cable television (CATV) signal overlayed on the same optical fiber at a different wavelength. In one embodiment, the first optical signal (e.g., the downstream digital data signal) may be at a wavelength of 1490 nm or in the 1490 nm window, the second optical signal (e.g., the downstream video signal) may be at a wavelength of 1550 nm or in the 1550 window, and the third optical signal (e.g., the upstream digital data signal) may be at a wavelength of 1310 nm or in the 1310 nm window. Other wavelengths and optical signals are within the scope of the system and method described herein.

Because the second optical signal (e.g., a multichannel video signal at λ₂) is overlayed with the first optical signal (e.g., a data signal at λ₁), the first and second optical signals may interfere due to SRS crosstalk depending upon the wavelengths and power levels of those signals. Because the optical signals are transmitted over optical waveguides or fibers, the impurities of the waveguides or fibers may cause RF phase variation due to DRBS. Thus, the crosstalk due to the SRS effect and the phase variation due to the DRBS effect may both be considered as contributors to CNR degradation in the optical network 100. In this exemplary embodiment, as will be described in greater detail below, optical transmission of the first and second optical signals (e.g., the downstream optical data and video signals) may be controlled to reduce CNR degradation of at least the optical video signal.

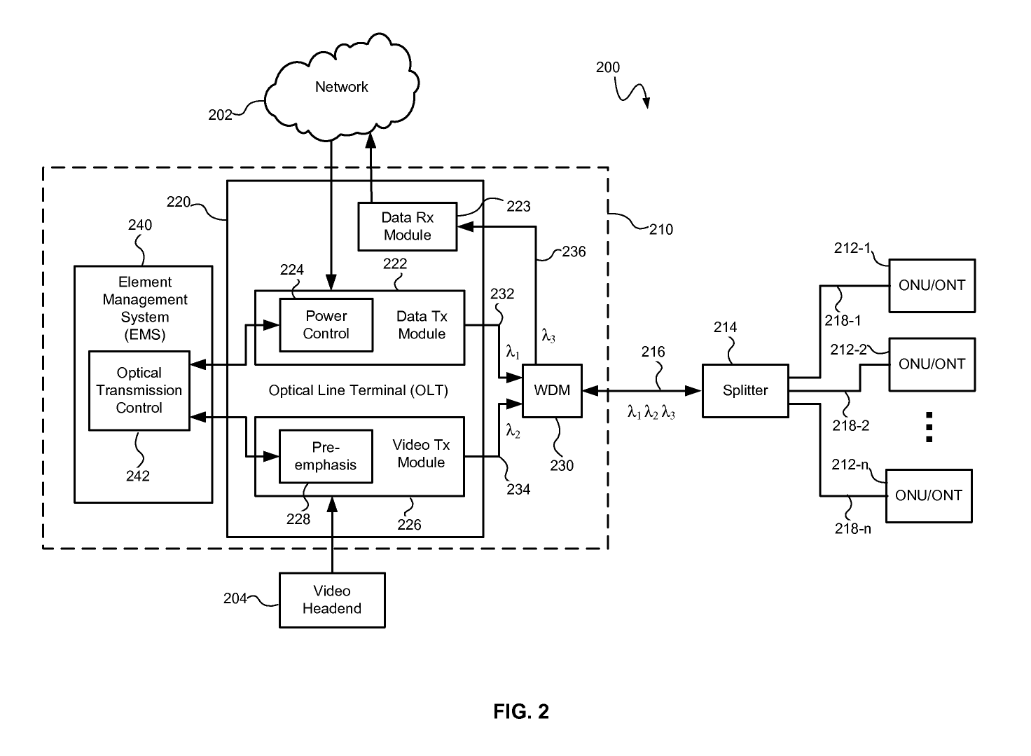

Referring to FIG. 2, one embodiment of an optical transmission system and method that controls optical transmission in an optical network 200 to reduce optical signal degradation is described in greater detail. As described above, the optical network 200 includes a CO node 210 coupled to a plurality of ONU/ONT nodes 212-1 to 212-n via optical transmission waveguides or fibers 216, 218-1 to 218-n and a splitter 214.

The CO node 210 may include at least one optical line terminal (OLT) 220 that transmits and receives the optical signals and that interfaces with a backbone data network 202 and video headend equipment 204. The OLT 220 may transmit and receive data to and from the data network 202, for example, using protocols known to those skilled in the art such as internet protocol (IP), voice over IP, and/or asynchronous transfer mode (ATM). The headend equipment 204 may include equipment located at the CO node 210 and/or remote equipment that receives video signals from various sources. The OLT 220 may receive video signals from the headend equipment 204, for example, as analog signals.

The OLT 220 may include a data transmitter module 222 and a video transmitter module 226. The data transmitter module 222 transmits data from the data network 202 as the downstream optical data signal 232 (e.g., carrying digital data and/or voice) at the first wavelength (λ₁) (also referred to as the digital channel). The video transmitter module 226 transmits the video signals from the headend equipment 204 as the downstream optical video signal 234 (e.g., a CATV signal) at the second wavelength (λ₂) (also referred to as the video channel). The OLT 220 may also include an optical receiver module 223 that receives an upstream optical data signal 236 at the third wavelength (λ₃). Transmitting optical data signals at a wavelength may include transmitting at a single wavelength and/or transmitting a WDM signal at multiple wavelengths closely spaced from the wavelength (i.e., within the wavelength window). In other words, any one of the first, second or third optical signals 232, 234, 236 may be WDM signals.

Although the exemplary embodiment shows the OLT 220 with a data transmitter module 222 and a video transmitter module 226, the data transmitter module 222 and video transmitter module 226 may also be separate OLTs. In some optical networks, for example, the data transmitter module 222 is referred to as the OLT and the video transmitter module 226 is referred to as the video OLT or V-OLT.

The CO node 210 may also include a wavelength division multiplexing (WDM) unit 230 such as a WDM filter or coupler. The WDM unit 230 combines the downstream optical video signal 234 (e.g., at 1550 nm) from the video transmitter module 226 with the downstream optical data signal 232 (e.g., at 1490 nm) from the data transmitter module 222. The WDM unit 230 may also route the upstream optical data signal 236 (e.g., at 1310 nm) to the data receiver module 223 in the OLT 220. The CO node 210 may also include other components, such as one or more optical amplifiers (not shown) that optically amplify the optical video signal 234. The same optical waveguide or fiber 216 carriers the combined downstream optical signals 232, 234 and the upstream optical signal 236; thus, the optical signals are susceptible to SRS crosstalk.

The data transmitter module 222 may include circuitry capable of receiving and formatting digital data (e.g., from the data network 202) for transmission over the optical network 200. The data transmitter module 222 may also include an optical transmitter that modulates an output of a laser with the formatted data to produce the downstream optical data signal 232. The data transmitter module 222 may further include power control 224, such as automatic power control (APC), to control the transmitted power of the optical data signal 232 generated and transmitted by the optical transmitter of the data transmitter module 222.

The video transmitter module 226 may include circuitry for modulating analog video signals (e.g., from the headend equipment 204) on RF carriers at different frequencies and for combining the modulated RF carriers to provide a multichannel RF signal. In one embodiment, the multichannel RF signal may be a CATV signal including, for example, 77 channels transmitted over a frequency range of about 50 MHz to 550 MHz or 110 channels transmitted over a frequency range of about 50 MHz to 750 MHz. Each channel in a downstream multichannel CATV signal may include a video carrier, a color subcarrier and an audio carrier. The multiple modulated analog carriers may be modulated using modulation techniques known to those skilled in the art, such as amplitude modulation, and may be combined using multiplexing techniques known to those skilled in the art, such as frequency division multiplexing. The multichannel RF signal may also include one or more digital signals modulated using digital modulation, such as quadrature amplitude modulation (QAM). Other types of multichannel video signals may also be generated in different frequency ranges using various modulation and multiplexing techniques.

The video transmitter module 226 may also include an optical transmitter with a laser that is directly modulated by the multichannel RF signal to produce the downstream optical video signal 234. The video transmitter module 226 may further include a preemphasis unit 228 that applies preemphasis to selected channels of the optical video signal 234, for example, by raising the optical modulation index (OMI) per channel of the modulated RF carriers at the preemphasis channels. The OMI is a measure of the degree of modulation of an optical carrier by a RF signal and may be represented as the ratio of the peak RF modulating current to the average modulating current. Each channel in the multichannel RF signal may be driven or modulated up to a certain OMI depending upon a desired channel-to-noise ratio (CNR) and other effects such as clipping distortion and saturation in the receiver. When multiple modulated carriers of a multichannel RF signal align in phase, for example, the sum of the voltage of the aligned carriers may result in a peak voltage condition. When the OMI of each channel exceeds a certain level (e.g., exceeding about 4% OMI per channel), the peak voltage condition may result in a higher occurrence of negative voltage spikes or peaks that cause the laser input current to fall below a threshold current of the laser, resulting in clipping and possibly clipping distortion.

The CO transmitter node 220 may further include an element management system (EMS) 240. The EMS 240 manages the network elements (e.g., the OLT and ONUs/ONTs) of the network 200. The management responsibilities of the EMS 240 may include fault, configuration, accounting, performance, and security (FCAPS) functions. The EMS 240 may be based on element management systems known to those skilled in the art for use with a PON.

The EMS 240 may include an optical transmission control 242 to control optical transmission by the data transmitter module 222 and/or by the video transmitter module 226. The optical transmission control 242 may be coupled to the power control 224 for adjusting the transmitted power of the optical data signal 232. The optical transmission control 242 may also be coupled to the preemphasis unit 228 for adjusting the preemphasis of the optical video signal 234. The EMS 240 including the optical transmission control 242 may be implemented as one or more software modules running on one or more EMS servers or host computers at the CO 210. The optical transmission control 242 may also be implemented separately from an EMS or as part of another system within the CO node 210.

The optical transmission control 242 obtains parameters affecting signal degradation and determines, based on those parameters, the signal adjustments that will reduce the signal degradation. According to the exemplary embodiment, the signal degradation is the CNR degradation in the optical video signal 234 caused by SRS and/or DRBS. The parameters obtained by the optical transmission control 242 may include, but are not limited to, the wavelengths of the optical signals (e.g., 1490 nm, 1550 nm), the fiber lengths, optical power information (e.g., transmitted power, received power, OMI), the type of network (e.g., EPON, BPON, GPON), the modulation current of the transmitter laser, and the chirp of the optical video signal 234.

The optical transmission control 242 may also communicate with the power control 224 and/or the preemphasis unit 228 to set the power of the optical data signal 232 and/or the preemphasis of the optical video signal 234 according to the determined adjustments that will reduce signal degradation. The optical transmission control 242 may be implemented, for example, as a software module employing an algorithm that considers the SRS and/or DRBS effects and attempts to adjust the preemphasis and/or transmitted power to reduce CNR degradation of the optical video signal caused by SRS and/or DRBS, as will be described in greater detail below. The adjustments made by the optical transmission control 242 may be fixed (e.g., before operating the optical network) based on the parameters measured at that time and/or may be performed dynamically (e.g., repeatedly or continually adjusted during operation) based on parameters that change over time.

The optical transmission control 242 may obtain at least some of the parameters from the OLT 220 and the ONU/ONT nodes 212-1 to 212-n. For example, the OLT 220 and the ONU/ONT nodes 212-1 to 212-n may include memory storing some of the parameters (e.g., the PON type and the wavelengths). The optical transmission control 242 may obtain the stored parameters, for example, through a built in transmitter interface via an I²C connection.

The OLT 220 and the ONU/ONT nodes 212-1 to 212-n may also determine other parameters (e.g., fiber length and optical power information) by measuring those parameters. For example, the OLT 220 and/or ONU/ONT nodes 212-1 to 212-n may provide an auto-ranging function. Auto-ranging is a technique known to those skilled in the art for measuring the distance between various nodes of a PON (e.g., the distance between the OLT 220 and the ONU/ONT nodes 212-1 to 212-n). The optical transmission control 242 may thus obtain the fiber length parameters from the measurements of these distances using the auto-ranging function. The OLT 220 and/or ONU/ONT nodes 212-1 to 212-n may also provide digital diagnostic monitor functions known to those skilled in the art. The digital diagnostic monitor function may be used, for example, to collect optical power information such as the power being received at the ONU/ONTs.

The ONU/ONT nodes 212-1 to 212-n may measure or collect the parameters during some calibration stage (e.g., prior to operation) and provide this data to the optical transmission control 242 to make the initial adjustments in preemphasis and/or transmitted power. The OLT 220 and the ONU/ONT nodes 212-1 to 212-n may also measure parameters at different times to determine if the parameters have changed and to update the adjustments in preemphasis and transmitted power. The fiber length and received power parameters may be measured, for example, when a new ONU/ONT is installed or another network change is made.

Additionally or alternatively, the optical transmission control 242 may obtain certain parameters during operation, such as the power of the optical data signal 232 from the data transmitter module 222 and the power and/or pre-emphasis parameters of the optical video signal 234 from the video transmitter module 226. The optical transmission control 242 may use these parameters to dynamically adjust the preemphasis and/or transmitted power during operation as these parameters change. The optical transmission control 242 may thus adjust the preemphasis and/or transmitted power based on relatively fixed parameters (e.g., the wavelengths, the type of PON, the fiber lengths, and the received optical power) and based on dynamic parameters (e.g., transmitted power).

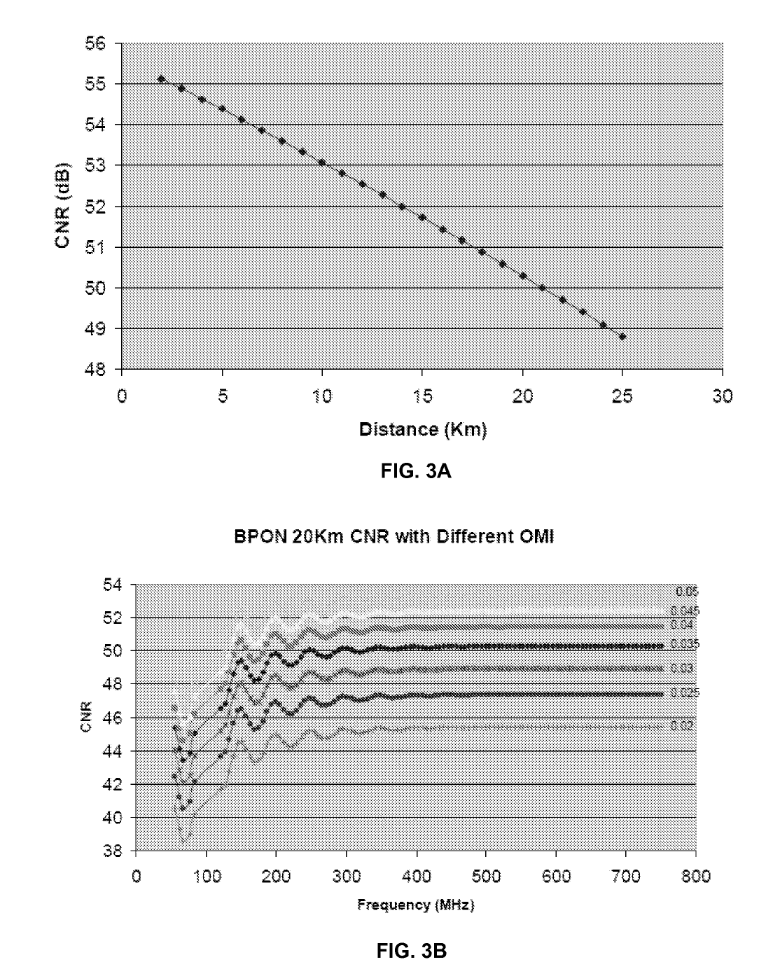

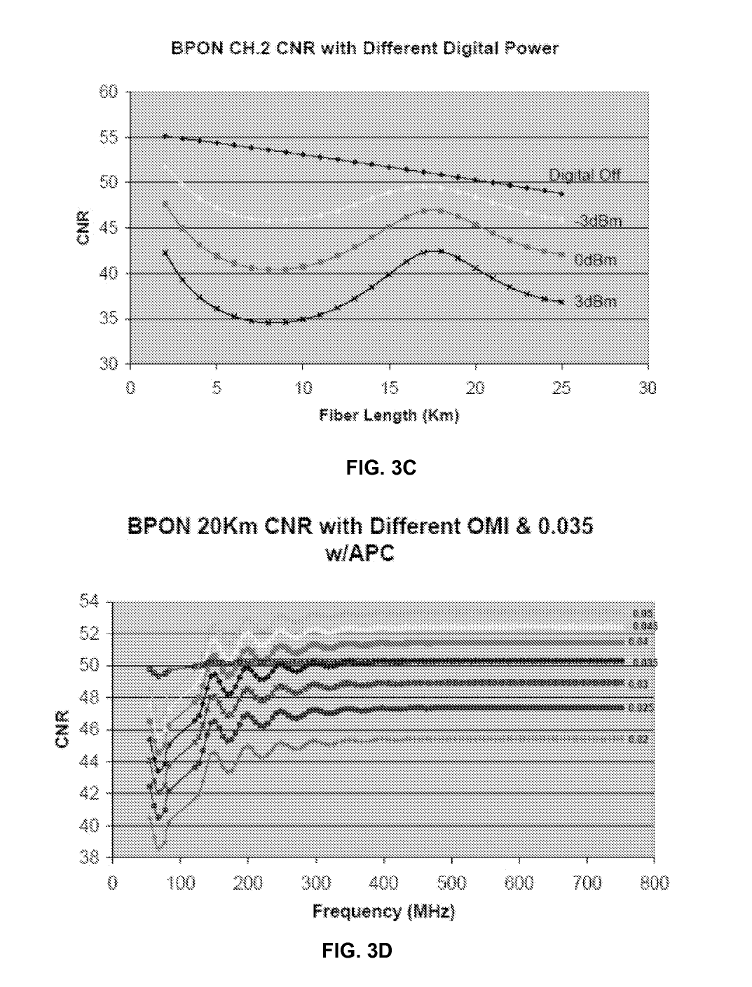

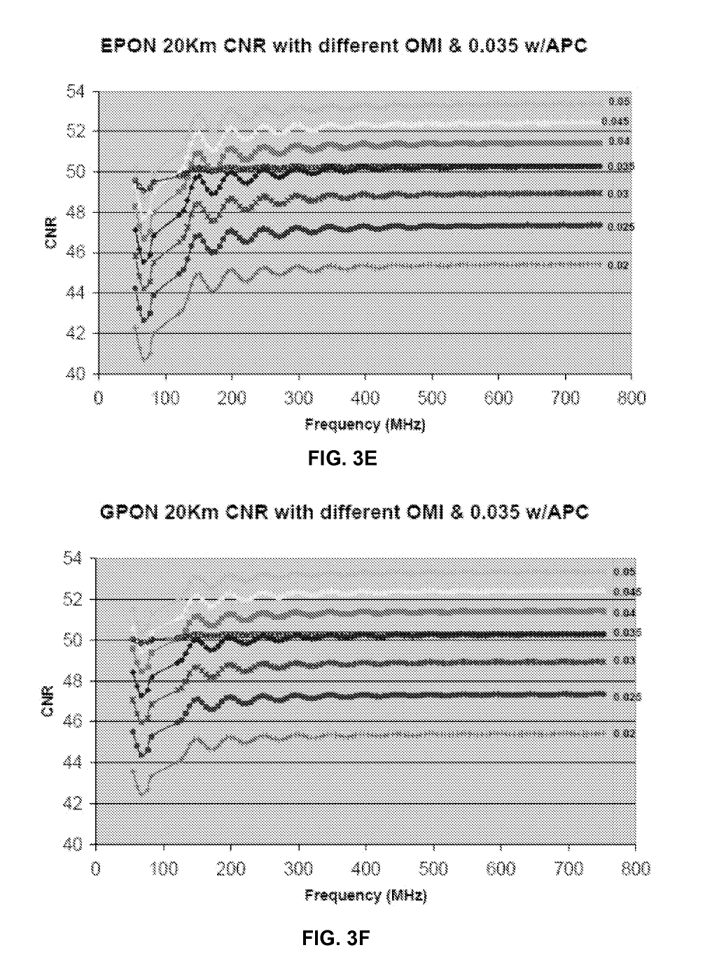

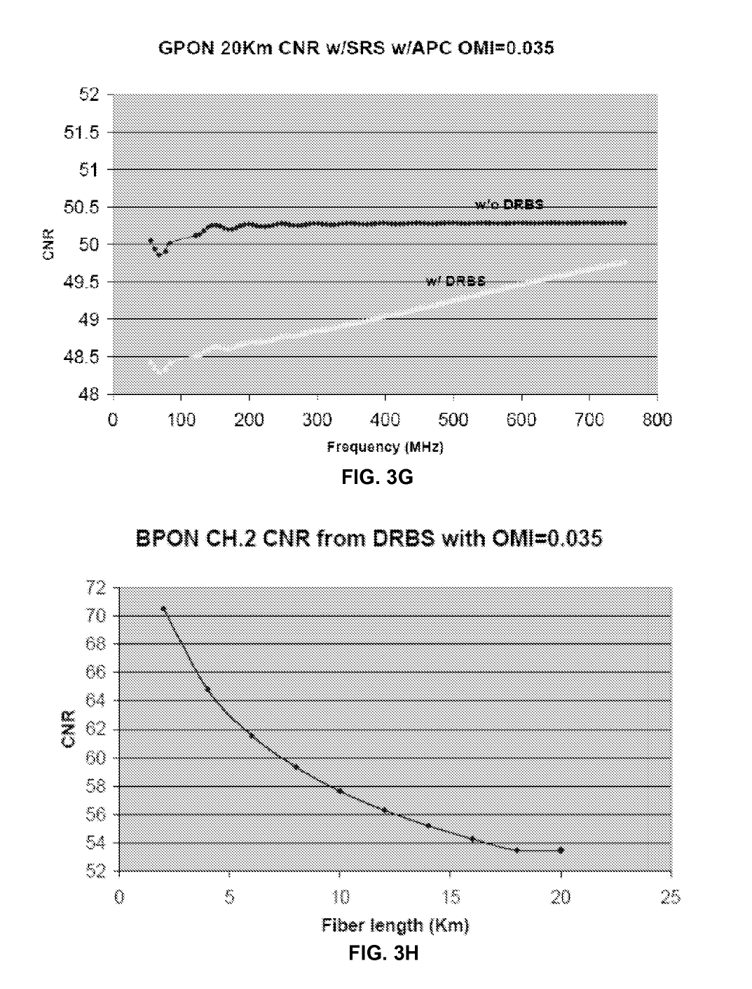

Referring to FIGS. 3A-3H, the CNR degradation and the affect of SRS and DRBS on the CNR degradation is discussed in greater detail in connection with simulations in an exemplary PON. In an optical network, CNR may have contribution from laser, receiver, and optical fiber. The laser contribution is mainly from relative intensity noise (RIN) caused by the spontaneous emission of photon, as shown in equation (1):
CNR_{RIN}=m²/(2.B.RIN) (1)
where m is the single channel optical modulation index (OMI) and B is the noise measurement bandwidth (e.g., 4.2 MHz for NTSC systems).

The first part of the receiver noise is from the shot noise, due to the random occurrence of photons and electrons, as shown in equation (2):
CNRₛₕₒₜ=m².ρ.P_{IN}/(4.q.B) (2)
where ρ is the receiver responsivity, P_{IN} is the optical input power, q is the electron charge, and m and B are defined as before.

The second part of the receiver noise is from thermal noise, generated in the resistor and amplifier following the detector, as shown in equation (3):
CNRₜₕₑᵣₘ=(m.ρ.P_{IN})²/(2.iₙ².B) (3)

where iₙ is the thermal noise equivalent current, and m, ρ, P_{IN}, and B are defined as before.

The total CNR from laser and receiver may be calculated by the combination of the laser and receiver contribution as in equation (4):
CNRₜₒₜₐₗ=10.log(10^{-(CNR}^{_{RIN}}^{/10)}+10^{-(CNR}^{ₛₕₒₜ}^{/10)}+10^{-(CNR}^{ₜₕₑᵣₘ}^{/10)}). (4)

FIG. 3A shows a calculated baseline CNR value for one example of a CATV system, where an OMI of 0.035 is used in the simulation. A baseline CNR value represents a CNR calculated for all video channels without considering the SRS effect. As shown, the baseline CNR value is lower for longer fiber lengths. For at least some applications, a value of 48 dB in CNR is an acceptable CNR in a BPON, EPON, and GPON. For a transmitted distance up to 20 Km, the calculated baseline CNR shown in FIG. 3A is in the range of this acceptable level for PON applications.

As mentioned above, the CNR in an optical network may be degraded as a result of non-linear effects, such as SRS and DRBS. Thus, the CNR may be lowered at some video channels from a calculated baseline CNR, which is referred to as the CNR penalty. To quantify the CNR penalty from SRS and/or DRBS, the contribution to CNR degradation from SRS and/or DRBS may be calculated.

The effect of SRS crosstalk may be represented by the carrier to crosstalk ratio (CCR) as shown in equation (5):

$$CCR = {( \frac{{A}_{eff} {m}_{signal}}{{ρ}_{SRS} {g}_{12} {P}_{xt} {m}_{xt}} )}^{2} \frac{{α}^{2} + {( 2 π f {d}_{12} )}^{2}}{1 + {ⅇ}^{- 2 α L} - 2 {ⅇ}^{- α L} cos ( 2 π f {d}_{12} L )} \qquad ( 5 )$$

where
A_{eff} is effective area of the optical fiber
m_{signal} is the optical modulation index of the video channel
ρ_{SRS} is the polarization overlap factor
g₁₂ is the Raman gain coefficient
Pₓₜ is the optical power of the interfering data signal
α is the attenuation coefficient of the fiber
f is the RF frequency
d₁₂ is the group velocity mismatch between the two signals
L is the fiber length
L_{eff} is the effective length of the fiber, defined as

$${L}_{eff} = \frac{1}{α} ( 1 - {ⅇ}^{- α L} ) ,$$

and
mₓₜ is the optical modulation index of the data channel.

The CNR contribution from SRS crosstalk can be expressed as shown in equation (6):
CNR_{SRS}=10.log(CCR) (6)

In the case where an interfering data channel is modulated by NRZ data, mₓₜ may be expressed as shown in equation (7):

$${m}_{st} \approx {\{ {\frac{4 B}{{R}_{b}} [ ( \frac{ɛ - 1}{ɛ + 1} ) ]}^{2} \frac{{sin}^{2} ( \frac{π f}{{R}_{b}} )}{{π}^{2} {f}^{2} / {R}_{b}^{2}} \}}^{6.5}$$

where ε is the extinction ratio of the data channel and R_{b} is the digital data transmitting rate.

These equations indicate that the SRS crosstalk is a function of various parameters, such as the Raman gain coefficient (which is a function of the wavelengths and wavelength separation), the fiber length, the type of PON (e.g., the OMI of the data channel and the data transmitting rate), and optical power information (e.g., the optical power of the interfering signal). As can be seen from equations (5) and (6), the SRS crosstalk (and thus the contribution to CNR degradation by SRS) may be reduced by increasing the OMI of the video channel (m_{signal}), by decreasing the OMI of the data channel (mₓₜ), and/or by decreasing data channel power (Pₓₜ). In some PONs, the data channel OMI is fixed according to the data channel transmitting rate specified by the PON standard; thus, adjusting the video channel OMI and data channel power may be the two primary options for reducing SRS crosstalk.

FIGS. 3B-3F illustrate the effect of adjusting the OMI and data channel power on CNR in different exemplary PONs based on simulations. The simulation for an exemplary BPON is based on the system parameters shown in Table 1 below. The simulations for an exemplary EPON and GPON are based on similar conditions with the exception of data channel transmitting rate (R_{b}), data channel receiver sensitivity, and optical modulation index of the data channel.

TABLE 1

| Parameter | Value | |
|---|---|---|
| RIN_{analog} | −165.0 | dB/Hz |
| m_{signal} | 3.5% | |
| B | 4.2 | MHz |
| P_{analog} | 17.5 | dBm |
| No. of Video Channel | 77 | |
| Video wavelength | 1550 | nm |
| Data wavelength | 1490 | nm |
| R_{b} | 622 | Mbps |
| Data Rx Sensitivity | 30 | dBm |
| S | 17 | dB |
| L max | 20 | km |
| α | 0.23 | dB/km |
| Power Budget Margin | 1 | dB |
| (g₁₂/A_{off}) | 0.34/W/km | |
| ρ_{SRS} | 0.5 | |
| d₁₂ | 1.03 | ns/km |
| Optical Splitter Loss | 16.5 | dB |
| Total Connector Loss | 1 | dB |

FIG. 3B shows the CNR as a function of frequency in a BPON with different video channel (or RF) OMI values and with SRS. FIG. 3B illustrates that increasing the video channel OMI increases the baseline CNR and that the affect of SRS crosstalk on CNR is smaller in higher video channels than in lower video channels. At the higher video channels, the CNR with the SRS effect is essentially the same as the calculated baseline CNR and thus the CNR penalty is negligible. At the lower video channels, the CNR penalty from SRS is significant and adjusting the video channel OMI alone may not improve the CNR value, affected by SRS, to an acceptable level (e.g., >48 dB).

FIG. 3C shows the CNR as a function of fiber length in a lower frequency video channel (Ch. 2) of a BPON with different digital data power values and with OMI=0.035. In this simulation, the fiber length represents the distance between the OLT and the ONU/ONT. FIG. 3C illustrates the effect of digital channel power on the SRS effect. In particular, decreasing the digital channel power (e.g., from 3 dBm to −3 dBm) improves CNR (e.g., by 7 dB to 11 dB depending on the fiber length). FIG. 3C also illustrates the oscillation of the CNR as a function of fiber length, which is due to the transfer of data channel energy into and away from the video channel. According to the illustrated oscillation, the worst case of SRS crosstalk penalty occurs at a fiber length of about 8 Km. The SRS effect may be ruled out after the splitter in any PON because of the reduction of digital power after the splitter. Thus, the SRS effect primarily affects the video signal between the WDM unit and the splitter.

The effect of the power of the data channel or signal on SRS degradation is also illustrated for different types of PONs in FIGS. 3D-3F. These simulations use a 20 Km fiber length representing the distance between the OLT and ONU/ONT in a worst case scenario for the CNR baseline value. FIG. 3D shows the CNR as a function of frequency in a BPON with different video channel (or RF) OMI values and with automatic power control (APC) at one of the OMI values (OMI=0.035). FIG. 3D illustrates that the CNR is improved with the OMI=0.035 and automatic power control (APC) with a 2 dB power budget margin (PBM) as compared to the CNR for the different OMI values with a 0 dBm digital power. By minimizing digital channel power using APC, the CNR of the lower channels is effectively raised closer to the baseline CNR value of the higher channels (i.e., the CNR penalty is reduced). FIG. 3D also indicates that control of the digital channel power alone may not be sufficient because an OMI of less than 0.025 has a baseline CNR value below an acceptable level (e.g., below 48 dB). Thus, both video channel OMI and the power of the digital data channel may be controlled to reduce the SRS effect and the CNR penalty and to maintain the CNR at an acceptable level (e.g., above 48 dB) for all video channels.

FIGS. 3E and 3F show the CNR as a function of frequency in an EPON and GPON, respectively, with different video channel (or RF) OMI values and with automatic power control (APC) at one of the OMI values (OMI=0.035). FIGS. 3D-3F illustrate that control of the OMI and digital channel power provide CNR improvement in each type of PON and that the CNR degradation under the same system configuration is in the order of GPON<EPON<BPON. In other words, the BPON with the lowest digital transmitting rate is affected by the SRS crosstalk more than the EPON and GPON.

As mentioned above, the DRBS effect may also be considered when determining the CNR penalty. The effect of DRBS may expressed as shown in equation (8):

$${RIN}_{DRB} = \frac{10}{9} {R}_{Rb}^{2} ( 2 α L + {ⅇ}^{- 2 α L} - 1 ) \frac{1}{{σ}_{f} \sqrt{π}} exp ( \frac{- {f}^{2}}{4 {σ}_{f}^{2}} ) . \qquad ( 8 )$$

where
α_{f}=Iₚγμ.
f is video channel RF frequency; R_{Rb} is Rayleigh backscattering reflectance; α is the attenuation coefficient of the fiber; L is the fiber length; Iₚ is the modulation current; γ is the laser chirping efficiency in MHz/mA; and μ is the rms OMI.

By combing equations (1) and (8), the contribution to CNR from DRBS can be calculated. These equations indicate that the DRBS effect is also a function of various parameters, for example, fiber length, modulation current, OMI, and laser chirping efficiency. As shown in equation (8), the digital data channel does not play a role in the DRBS. The effect of DRBS is primarily attributed to the chirping of the direct modulated laser (e.g., in a video transmitter module). FIGS. 3G and 3H illustrate the effect of DRBS in different exemplary systems based on simulations. The parameter values used in the simulations are as follows: R_{Rb}=−33.2 dB; α=0.23 dB/Km; Iₚ=30 mA; γ=50 MHz/mA; and μ=0.217.

FIG. 3G shows the CNR as a function of frequency for a 20 Km transmitting distance in a GPON with SRS and with APC and an OMI=0.035. FIG. 3G illustrates that DRBS causes further degradation of CNR and that the degradation of CNR from DRBS is not uniform across video channels. The CNR degradation from DRBS changes linearly from 1.5 dB at the low channel to 0.5 dB at the high channel. Thus, the CNR degradation from DRBS is higher in lower channels.

FIG. 3H shows the CNR from DRBS as a function of fiber length in a lower frequency channel (Ch. 2) of a BPON with OMI=0.035. FIG. 3H illustrates that DRBS affects the video channel signal more with longer fiber length. Thus, the CNR penalty and degree of CNR degradation may be reduced by considering the effects of both DRBS and SRS and by applying a preemphasis to the lower video channels and by using APC to reduce the digital channel power.

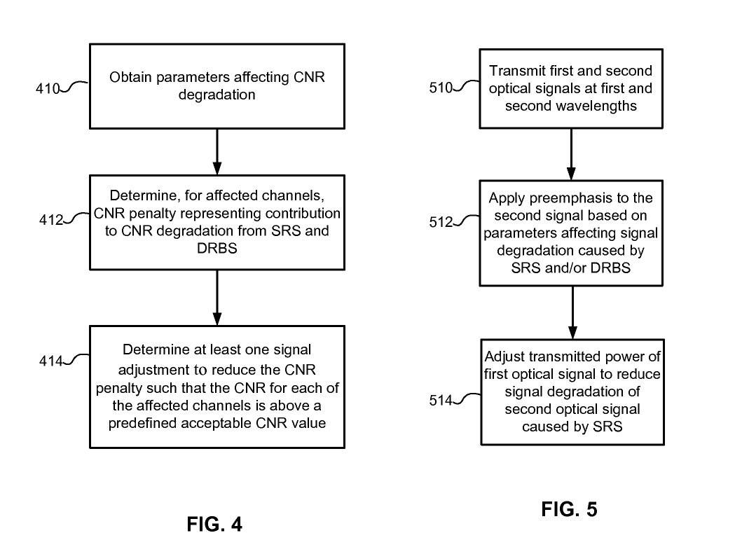

Referring to FIGS. 4-6, various methods consistent with embodiments of the present invention are illustrated and described. The illustrated methods may be performed using the embodiments of the optical networks 100, 200 and optical transmission systems described above or using variations of those networks and systems. Variations of these methods are also within the scope of the present invention.

FIG. 4 shows a method for controlling optical signal transmission to reduce CNR degradation in an optical network transmitting first and second optical signals at first and second wavelengths. This method may be implemented in software, for example, as part of an EMS as described above. According to this method, at least the second channel is a multichannel optical signal (e.g., a CATV signal) that is susceptible to CNR degradation as a result of SRS interference with the first optical signal and the effects of DRBS. This method obtains 410 parameters affecting the CNR degradation and determines 412, for affected channels, a CNR penalty representing a contribution to CNR degradation from SRS and DRBS. Affected channels are channels of the second optical signal in which CNR degradation causes the CNR to fall below a predefined acceptable level (e.g., 48 dB) for the optical network. The predefined acceptable CNR value may be established based on various standards and/or service provider requirements. The parameters may include any of the parameters described above as affecting CNR degradation and may be obtained using the techniques described above. The CNR penalty may be determined by calculating a value that represents CNR degradation from SRS and DRBS (e.g., the difference between a baseline CNR value and a CNR value with both SRS and DRBS taken into account). The CNR and CNR penalty may be calculated, for example, using the equations described above, from variations of those equations, or using other techniques known to those skilled in the art.

The method then determines 414 an optical signal adjustment to reduce the CNR penalty such that the CNR for each of the affected channels is above the predefined acceptable CNR value. As described above, the optical signal adjustment may be a preemphasis (e.g., an OMI value) to be applied to the second optical signal and/or an adjustment of the transmitted power (e.g., a transmitted power value) of the first optical signal. This signal adjustment may also be determined at various stages before and/or during operation of the optical transmission system and may be determined dynamically based on parameters that change dynamically, as discussed above.

FIG. 5 shows a method for transmitting optical signals with reduced optical signal degradation in an optical network. This method may be implemented in hardware and/or software, for example, by the OLT described above. According to this method, the first and second optical signals are transmitted 510 at the first and second wavelengths over an optical waveguide from a transmitter node to a receiver node (e.g., from an OLT to an ONU/ONT). Preemphasis is applied 512 to the second signal (i.e., to the multichannel optical video signal) based on parameters affecting signal degradation caused by SRS and/or DRBS, for example, as described above. The preemphasis may be adjusted at different times or dynamically, for example, based on optical power information. The transmitted power of the first optical signal may also be adjusted 514 to reduce degradation of the second optical signal caused by SRS.

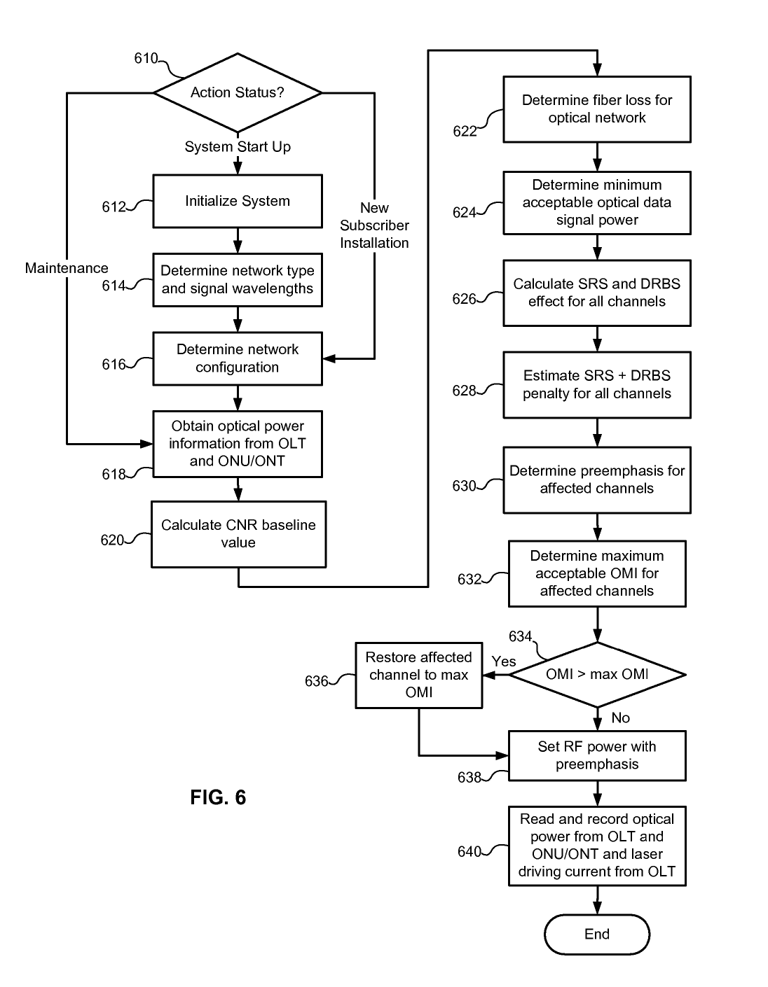

FIG. 6 shows another method for controlling optical signal transmission in an optical network to reduce CNR degradation caused by SRS and DRBS. This method may be implemented in software, for example, as part of an EMS as described above. This method determines 610 the action status of the optical transmission system and then obtains parameters based on the action status. The action status may include a system start up for the first time, a new subscriber installation (e.g., a new ONU/ONT node), and a regular scheduled maintenance. If the system is starting up for the first time, the system is initialized 612, for example, to set the power of the optical signals (e.g., the video and data signals) to a default value. The network type (e.g., the PON type) and the optical signal wavelengths (e.g., of the video and data channels) may then be determined 614, for example, by reading these parameters through the transmitter interface. The network configuration (e.g., the distances between nodes and the fiber lengths) may then be determined 616, for example, through auto-ranging from the ONU/ONT nodes. If the action status is a new subscriber installation, the method may skip the initialization 612 and network type and signal wavelength determination 614 and proceed to the network configuration determination 616. The optical power information may then be obtained 618 from the OLT and/or ONU/ONT, for example, using a digital diagnostic monitor function. If the action status is a scheduled maintenance, the method may also skip the network configuration determination 616 and proceed directly to obtaining 618 the optical power information.

The method may then calculate 620 a CNR baseline value, for example, from the video signal optical power value obtained from the ONU/ONT. The fiber loss for the optical network may then be determined 622, for example, from the data signal optical power information obtained from the OLT and ONU/ONT. The fiber loss may include losses in the fiber path between the OLT and the ONU/ONT from fiber attenuation, splitter loss, and connection loss. A minimum optical data signal (or digital channel) power may be determined 624, for example, based on a highest fiber loss value and an acceptable power budget margin.

The SRS and DRBS effects may then be calculated 626 for all channels in the optical video signal. The SRS effect may be calculated, for example, using the equation above for the carrier to crosstalk ratio (CCR). The DRBS effect may be calculated, for example, using the equation above for the RIN_{DRB}. Variations of these equations or other equations for calculating SRS and DRBS effects may also be used. The calculation of the SRS effect may use the fiber length at which the SRS effect is the worst (e.g., at 8 Km). The CNR baseline and DRBS calculations may be based on the measured distance between the OLT and ONU/ONT.

The CNR penalty from SRS and DRBS may then be estimated 628 for all channels of the optical video signal based on the parameters that were obtained and the minimum optical data signal power. The CNR penalty may be estimated, for example, by determining the extent to which the SRS and DRBS effects cause the CNR to fall below the baseline CNR. Preemphasis may then be determined 630 for the affected channels at which the CNR penalty causes CNR to fall below an acceptable CNR value. The preemphasis may be determined, for example, by determining the OMI at each of the affected channels that will reduce the CNR penalty such that the CNR is raised a predefined acceptable CNR value.

The maximum acceptable OMI may then be determined 632 for the preemphasis channels. The maximum acceptable OMI may be the maximum OMI that can be set without causing other undesired effects such as clipping distortion and saturation in the RF receiver. The preemphasis OMI of the preemphasis channels is then compared 634 with the maximum acceptable OMI for those channels. If the preemphasis OMI of the preemphasis channels do not exceed the maximum acceptable OMI for those channels, the RF power may be set 638 with the preemphasis. If the preemphasis OMI of a preemphasis channel exceeds the maximum acceptable OMI 634, the OMI of the affected channel may be restored 636 to the maximum acceptable OMI before the RF power is set 638 with the preemphasis. The method may then read and record 640 the optical power of the data and video signals from the OLT and ONU/ONT and the laser driving current from the OLT.

Accordingly, the optical transmission system and methods described herein are capable of reducing optical signal degradation caused by SRS and/or DRBS.

Consistent with one embodiment, a method is provided for controlling optical signal transmission to reduce degradation of a carrier to noise ratio (CNR) in an optical network transmitting at least first and second optical signals at first and second wavelengths, respectively, over at least one optical waveguide from a transmitter node to at least one receiver node. The method includes obtaining parameters affecting CNR degradation of the second optical signal; determining, responsive to the parameters, a CNR penalty for multiple affected channels in the second optical signal, the CNR penalty representing a contribution to CNR degradation from stimulated Raman scattering (SRS) and double Rayleigh backscattering (DRBS); and determining at least one optical signal adjustment to reduce the CNR penalty such that the CNR for each of the affected channels is above a predefined acceptable CNR value.

Consistent with another embodiment, a method is provided for transmitting optical signals with reduced optical signal degradation in an optical network. The method includes transmitting first and second optical signals at first and second wavelengths, respectively, over at least one optical waveguide from a transmitter node to at least one receiver node in an optical network. The method further includes applying preemphasis to the second optical signal at the transmitter node to reduce degradation of the second optical signal caused by at least stimulated Raman scattering (SRS). The preemphasis is based on parameters affecting signal degradation including the first and second wavelengths, length of the at least one optical waveguide, and transmission power levels of the first and second optical signals.

Consistent with a further embodiment, an optical transmission system includes at least first and second optical transmitters configured to transmit at least first and second optical signals at first and second wavelengths, respectively, over an optical waveguide to at least one receiver. The second optical transmitter includes a preemphasis unit configured to apply preemphasis to the second optical signal. The optical transmission system also includes an element management system configured to determine the preemphasis, based on parameters affecting signal degradation, to be applied by the preemphasis unit to the second optical signal to reduce degradation of the second optical signal caused by at least stimulated Raman scattering (SRS). The parameters affecting signal degradation include the first and second wavelengths, lengths of the at least one optical waveguide, and transmission power levels of the first and second optical signals.

Embodiments of the system and method for controlling optical transmission to reduce optical signal degradation can be implemented as a computer program product for use with a computer system (e.g., as a component of the EMS software). Such implementations include, without limitation, a series of computer instructions that embody all or part of the functionality previously described herein with respect to the system and method. The series of computer instructions may be stored in any machine-readable medium, such as semiconductor, magnetic, optical or other memory devices, and may be transmitted using any communications technology, such as optical, infrared, microwave, or other transmission technologies. It is expected that such a computer program product may be distributed as a removable machine-readable medium (e.g., a diskette, CD-ROM), preloaded with a computer system (e.g., on system ROM or fixed disk), or distributed from a server or electronic bulletin board over the network (e.g., the Internet or World Wide Web).

Those skilled in the art should appreciate that such computer instructions can be written in a number of programming languages for use with many computer architectures or operating systems. For example, preferred embodiments may be implemented in a procedural programming language (e.g., “C”) or an object oriented programming language (e.g., “C++” or Java). Alternative embodiments of the invention may be implemented as pre-programmed hardware elements, firmware or as a combination of hardware, software and firmware.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method for controlling optical signal transmission to reduce degradation of a carrier to noise ratio (CNR) in an optical network transmitting at least first and second optical signals at first and second wavelengths, respectively, over at least one optical waveguide from a transmitter node to at least one receiver node, the method comprising:
obtaining parameters affecting CNR degradation of the second optical signal;
determining, responsive to the parameters, a CNR penalty for multiple affected channels in the second optical signal, the CNR penalty representing a contribution to CNR degradation from stimulated Raman scattering (SRS) and double Rayleigh backscattering (DRBS); and
determining at least one optical signal adjustment to reduce the CNR penalty such that the CNR for each of the affected channels is above a predefined acceptable CNR value.

2. The method of claim 1 wherein the parameters comprise at least the first and second wavelengths, a length of the optical waveguide, and optical power information

3. The method of claim 1 wherein determining the at least one signal adjustment includes establishing a preemphasis optical modulation index (OMI) for the affected channels of the second optical signal, the preemphasis OMI being the OMI that will reduce the CNR penalty such that the CNR for each of the affected channels is above the predefined acceptable CNR value.

4. The method of claim 3 further comprising:
determining a maximum acceptable OMI for the affected channels; and
restoring the preemphasis OMI to the maximum acceptable OMI if the preemphasis OMI is determined to be greater than the maximum acceptable OMI.

5. The method of claim 3 wherein determining the at least one signal adjustment includes determining a reduction in transmitted power of the first optical signal.

6. The method of claim 3 further comprising minimizing a transmitted power of the first optical signal within a predefined power budget margin.

7. The method of claim 1 further comprising monitoring optical power information, and wherein determining the at least one signal adjustment includes dynamically determining the signal adjustment in response to the optical power information.

8. The method of claim 1 wherein the first optical signal is a digital data signal and the second optical signal is a multichannel analog video signal.

9. The method of claim 1 wherein the optical network includes a passive optical network (PON), wherein the transmitter node includes an optical line terminal (OLT), and wherein the receiver node includes an optical network unit (ONU) or an optical network termination (ONT).

10. The method of claim 9 wherein the parameters include a type of PON.

11. The method of claim 10 wherein the type of PON is selected from the group consisting of an Ethernet Passive Optical Network (EPON), a Broadband Passive Optical Network (BPON) and a Gigabit Passive Optical Network (GPON).

12. A machine-readable medium whose contents, when executed by a computer system, cause the computer system to perform the method of claim 1.

13. A method for transmitting optical signals with reduced optical signal degradation in an optical network, comprising:
transmitting first and second optical signals at first and second wavelengths, respectively, over at least one optical waveguide from a transmitter node to at least one receiver node in an optical network; and
applying preemphasis to the second optical signal at the transmitter node to reduce degradation of the second optical signal caused by at least stimulated Raman scattering (SRS), wherein the preemphasis is based on parameters affecting signal degradation including the first and second wavelengths, length of the at least one optical waveguide, and transmission power levels of the first and second optical signals.

14. The method of claim 13 wherein the optical network has a type selected from the group consisting of an Ethernet Passive Optical Network (EPON), a Broadband Passive Optical Network (BPON) and a Gigabit Passive Optical Network (GPON), and wherein the preemphasis is further based on the type of optical network.

15. The method of claim 13 wherein the preemphasis is further based on optical power information indicative of received optical power at the at least one receiver node.

16. The method of claim 15 further comprising adjusting the preemphasis based on the received optical power at the at least one receiver node and the transmission power levels of the first and second optical signals.

17. The method of claim 13 further comprising adjusting transmitted power of the first optical signal to reduce degradation of the second optical signal caused by at least SRS.

18. The method of claim 13 further comprising determining, responsive to the parameters, a carrier to noise ratio (CNR) penalty for multiple affected channels in the second optical signal, the CNR penalty representing a contribution to CNR degradation from stimulated Raman scattering (SRS) and double Rayleigh backscattering (DRBS), and wherein the preemphasis is applied to reduce the CNR penalty such that the CNR for each of the affected channels is above a predefined acceptable CNR value.

19. The method of claim 13 wherein applying the preemphasis includes increasing the optical modulation index (OMI) of at least one affected channel of the second optical signal.

20. The method of claim 19 further comprising:
determining a maximum acceptable OMI for the at least one affected channel, wherein the OMI of the affected channel is not increased higher than the maximum acceptable OMI.

21. A system for controlling optical signal transmission to reduce degradation of a carrier to noise ratio (CNR) in an optical network, the optical network comprising a transmitter node, at least one receiver node and at least one optical waveguide, the transmitter node being configured to transmit at least first and second optical signals at first and second wavelengths, respectively, over the at least one optical waveguide to the at least one receiver node, the system comprising:
means for obtaining parameters affecting CNR degradation of the second optical signal;
means for determining, responsive to the parameters, a CNR penalty for multiple affected channels in the second optical signal, the CNR penalty representing a contribution to CNR degradation from stimulated Raman scattering (SRS) and double Rayleigh backscattering (DRBS); and
means for determining at least one optical signal adjustment to reduce the CNR penalty such that the CNR for each of the affected channels is above a predefined acceptable CNR value.

22. The system of claim 21 the means for determining the at least one signal adjustment establishes a preemphasis optical modulation index (OMI) for the affected channels of the second optical signal, the preemphasis OMI being the OMI that will reduce the CNR penalty such that the CNR for each of the affected channels is above the predefined acceptable CNR value.

23. The system of claim 22 wherein the means for determining the at least one signal adjustment determines a reduction in transmitted power of the first optical signal.

24. An optical transmission system comprising:
at least first and second optical transmitters configured to transmit at least first and second optical signals at first and second wavelengths, respectively, over an optical waveguide to at least one receiver, the second optical transmitter including a preemphasis unit configured to apply preemphasis to the second optical signal; and
an element management system configured to determine the preemphasis, based on parameters affecting signal degradation, to be applied by the preemphasis unit to the second optical signal to reduce degradation of the second optical signal caused by at least stimulated Raman scattering (SRS), the parameters affecting signal degradation including the first and second wavelengths, lengths of the at least one optical waveguide, and transmission power levels of the first and second optical signals.

25. The optical transmission system of claim 24 wherein the first optical transmitter includes a power control configured to control transmitted power of the first optical signal, and wherein the element management system is configured to determine the transmitted power of the first optical signal to reduce degradation of the second optical signal caused by at least stimulated Raman scattering (SRS).
